(19) United States
(12) Patent Application Publication
(10) Pub. No.: US 2026/0300616 A1
(43) Pub. Date: Oct. 1, 2026

(54) MACHINE LEARNING-BASED DOCUMENT AUDIT SYSTEM WITH GRAPHICAL USER INTERFACE

(71) Applicant: Thomson Reuters Enterprise Centre GmbH, Zug (CH)

(72) Inventors: Gabriela Cristina Todor, Mississauga (CA); Gabriela Equihua Ortega, Mexico City (MX)

(21) Appl. No.: 19/634,764

(22) Filed: Mar. 31, 2026

Related U.S. Application Data
(60) Provisional application No. 63/781,009, filed on Mar. 31, 2025.

(51) Int. Cl. G06F 40/169; G06N 20/00

(52) U.S. Cl. CPC G06F 40/169; G06N 20/00

(57) ABSTRACT

A system includes a machine learning (ML)-based document audit platform with a graphical user interface (GUI). The system receives one or more source document data files and performs data pre-processing operations to transform the one or more source document data files into one or more labelled data files. The system also executes one or more audit subroutines on the one or more labelled data files to generate at least one of a grouped data output or a batched data output. The grouped data output or the batched data output is provided to one or more ML models of a machine learning model layer configured to identify one or more issues and generate one or more reason texts associated with the one or more issues. The system causes the GUI to present a document view including one or more visual indicators representing the issue(s), and the reason text(s).

### CROSS-REFERENCE TO RELATED APPLICATIONS

The present application claims the benefit of priority from U.S. Provisional Application No. 63/781,009 filed Mar. 31, 2025 and entitled “SYSTEMS AND METHODS FOR AI INVOICE REVIEW,” which is incorporated by reference herein in its entirety.

### TECHNICAL FIELD

The present application is generally directed to machine learning-based software with a graphical user interface. and, in particular, document analysis software.

### BACKGROUND

Document review software is used to analyze data-dense electronic documents containing combinations of narrative text, numerical values, categorical fields, timestamps, identifiers, and other structured or unstructured content. In many environments, such documents originate from different source systems and are generated in different file formats, schemas, or transmission standards. This creates technical challenges because the same document may include freeform descriptive content that benefits from contextual interpretation together with discrete fields that are more appropriately evaluated using threshold logic or consistency analysis. Moreover, the enormous volume of documents being reviewed by large enterprises introduces issues of scale where processing requirements and memory storage requirements become significant obstacles.

### BRIEF SUMMARY

The systems, methods, and devices disclosed herein can address the aforementioned issues. For instance, a system can include one or more processors, a display presenting a graphical user interface (GUI), and one or more non-transitory memory storage device storing computer-readable instructions which, upon being executed by the one or more processors, can cause the system to perform the operations disclosed herein. The operations can include assigning one or more task code labels or expense code labels to one or more formatted document data files to transform the formatted document data files into one or more labelled data files. Also, the operations can include selecting one or more audit subroutines from a plurality of audit subroutines based on previously-stored subroutine designation instructions corresponding to at least one of the one or more task code labels, executing one or more audit subroutines on the one or more labelled data files to generate one or more subroutine outputs (e.g., a grouped data output or a batched data output), and providing the one or more subroutine outputs to one or more machine learning (ML) models of an ML model layer. The one or more ML models can identify one or more issues from the one or more subroutine outputs and can generate one or more reason texts associated with the one or more issues. Also, the operations can include causing the display to present a document view at the GUI. The document view can include a document identifier corresponding to the one or more source document data files, one or more visual indicators representing the one or more issues, and the one or more reason texts associated with the one or more issues.

In some instances, the pre-processing operations can include receiving the one or more source document data files, performing a format conversion procedure on the source document data files to generate one or more formatted data files, and assigning one or more task code labels to the one or more formatted data files resulting in the one or more labelled data files. Furthermore, executing the one or more audit subroutines can include selecting the one or more audit subroutines from a group of audit subroutines based on the one or more labelled data files. In some examples, the group of audit subroutines can include an intra-document document line item (DLI) audit subsystem, a cross-document DLI audit subsystem, a non-compliant fee audit subsystem, and a benchmark audit subsystem.

Moreover, in some cases, the executing of the one or more audit subroutines can include grouping line items from a same source document data file to generate the grouped data output provided to the one or more ML models, grouping line items from multiple source document data files to generate the grouped data output provided to the one or more ML models, batching line items that correspond to non-compliant fees to generate the batched data output provided to the one or more ML models, or batching line items that correspond to a benchmark threshold to generate the batched data output provided to the one or more ML models.

In some scenarios, the one or more audit subroutines can include a plurality of audit subroutines, and the one or more ML models can include a plurality of ML models, with individual ML models of the plurality of ML models corresponding to individual audit subroutines of the plurality of audit subroutines. Additionally, the system can aggregate duplicate line item information based on outputs of the plurality of ML models, consolidate non-compliant fee data based on the outputs of the plurality of ML models, and consolidate outlier data based on the outputs of the plurality of ML models.

In some instances, the one or more visual indicators representing the one or more issues can correspond to at least one of aggregated duplicate line item information, consolidated non-compliant fee information, or consolidated outlier data. Also, the document view can include a visual task code indicator representing a task code associated with the one or more issues, a visual suggested task code indicator generated by the ML model layer representing a suggested task code to replace the task code associated with the one or more issues, a textual narrative representing a reason for the suggested task code, and an interactive GUI element that, upon receiving a user input, can cause the task code to be replaced with the suggested task code in the one or more source document data files.

In some examples, a device can include one or more processors and one or more non-transitory memory storage device storing computer-readable instructions which, upon being executed by the one or more processors, can cause the device to perform operations. The operations can include receiving one or more source document data files, performing data pre-processing operations on the one or more source document data files to transform the one or more source document data files into one or more formatted data files and to transform the one or more formatted data files into one or more labelled data files, executing one or more audit subroutines on the one or more labelled data files to generate at least one of a grouped data output or a batched data output, and providing the grouped data output or the batched data output to one or more ML models of a ML model layer.

Furthermore, in some scenarios, the one or more ML models can identify one or more issues from the grouped data output or the batched data output and can generate one or more reason texts associated with the one or more issues. Moreover, the operations can include causing a display to present a document view at a graphical user interface (GUI), the document view including one or more visual indicators representing the one or more issues and the one or more reason texts associated with the one or more issues.

In some instances, the document view can include a spending summary section presenting, based on at least one of the grouped data output or the batched data output, a first visual indicator showing matter spending for a fiscal year as compared to an annual budget and a second visual indicator showing matter spending over a lifetime of a matter as compared to a lifetime budget. Additionally, the document view can include a flagged issue indicator section presenting selectable issue indicators corresponding to different audit types. In some scenarios, the document view can include a document data section presenting a timeline of activity associated with the one or more source document data files, and can include a document processing data section presenting approval progression activity and pending actions for the one or more source document data files. Also, the document view can include a related matter data section presenting matter-specific data associated with the one or more source document data files and including an interactive element configured to present an option to change matter information associated with the one or more source document data files.

In some examples, the document view can include a list of a plurality of issue category indicators, and individual issue category indicators of the plurality of issue category indicators can include a number indicator representing a number of issues corresponding to the individual issue category indicators. Furthermore, the document view can include an interactive element associated with the one or more visual indicators that, upon receiving a user input, can cause a section of the document view to present underlying document data associated with the one or more visual indicators.

In some instances, a computer-implemented method can include receiving, by one or more processors, one or more source document data files, performing, by the one or more processors, data pre-processing operations on the one or more source document data files to transform the one or more source document data files into one or more formatted data files and to transform the one or more formatted data files into one or more labelled data files, and executing, by the one or more processors, one or more audit subroutines on the one or more labelled data files to generate at least one of a grouped data output or a batched data output.

Moreover, the method can include providing, by the one or more processors, the grouped data output or the batched data output to one or more ML models of a ML model layer with instructions to identify one or more issues from the grouped data output or the batched data output and generate one or more reason texts associated with the one or more issues. The method can also include causing, by the one or more processors, a display to present a document view at a graphical user interface (GUI), the document view including one or more visual indicators representing the one or more issues and the one or more reason texts associated with the one or more issues.

The foregoing has outlined rather broadly the features and technical advantages of the present technology in order that the detailed description of the disclosed technology that follows may be better understood. Additional features and advantages of the disclosed technology will be described hereinafter which form the subject of the claims of the disclosed technology. It should be appreciated by those skilled in the art that the conception and specific embodiment disclosed may be readily utilized as a basis for modifying or designing other structures for carrying out the same purposes of the presently disclosed technology. It should also be realized by those skilled in the art that such equivalent constructions do not depart from the spirit and scope of the disclosed technology as set forth in the appended claims. The novel features which are believed to be characteristic of the present disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the presently disclosed technology.

### BRIEF DESCRIPTION OF THE DRAWINGS

For a more complete understanding of the presently disclosed technology, reference is now made to the following descriptions taken in conjunction with the accompanying drawings, in which:

FIGS. 1A and 1B depict an example system including a machine learning (ML)-based document audit system.

FIGS. 2A and 2B depict an example system including a graphical user interface (GUI) for presenting a single-view data arrangement of data outputted by the ML-based document audit system.

FIGS. 3A-3G depict an example system including sections of the GUI for the ML-based document audit system.

FIG. 4 depicts an example system including a network architecture for implementing the ML-based document audit system.

FIG. 5 depicts an example method for generating a GUI of an ML-based document audit system.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

Although the presently disclosed technology and its advantages have been described in detail, it should be understood that various changes, substitutions and alterations can be made herein without departing from the spirit and scope of the disclosed technology as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed technology, processes, machines, manufacture, compositions of matter, means, methods, or steps, presently existing or later to be developed that perform substantially the same function or achieve substantially the same result as the corresponding embodiments described herein may be utilized according to the presently disclosed technology. Accordingly, the appended claims are intended to include within their scope such processes, machines, manufacture, compositions of matter, means, methods, or steps.

Document review workflows often rely on manual inspection, isolated rules engines, or separate analysis tools that process different aspects of the same document independently. For example, a system may evaluate descriptive entries using one routine, classification or coding information using another routine, and numerical patterns or benchmark comparisons using still other routines. These operations are often executed across disconnected processing modules, screens, reports, or applications that do not share a common intermediate data representation or synchronized data analysis state. As a result, the underlying computing environment may repeatedly parse the same source data, perform overlapping comparison operations, maintain duplicative working copies of related document content, and generate separate interface states or output artifacts for partially overlapping review tasks.

Additional technical limitations arise when analysis approaches are applied to documents containing both language-based content and value-based content. Systems optimized for keyword searching or static text matching may fail to detect semantically related entries expressed using different wording, while systems optimized for rigid field validation may fail to identify inconsistencies that depend on contextual interpretation of descriptive content. Similarly, isolated rule-based tools may not reliably identify anomalies that become apparent only when document content is evaluated in relation to historical data, external benchmark data, or collections of related documents. Where source data is incomplete, inconsistently formatted, or extracted from non-standard files, errors in normalization or classification may further propagate through downstream processing stages and reduce accuracy and reliability of automated review.

Accordingly, the computer-implemented systems and methods disclosed herein are capable of processing heterogeneous electronic documents using coordinated analysis of textual data, numerical data, and categorical data within a shared data processing framework. These systems can normalize disparate inputs, reduce redundant processing and storage of duplicative intermediate results, and present consolidated data outputs through a unified graphical user interface. Such systems may improve efficiency and scalability, reduce error propagation, and increase reliability of machine-assisted review across a wide variety of document processing environments.

In some examples, the machine learning (ML)-based document review software disclosed herein can be used to review document information, such as invoice information associated with outside counsel billing. A document audit system may receive structured, semi-structured, or unstructured document inputs and may convert the document inputs into a normalized representation suitable for downstream processing. The system may perform data pre-processing operations to the document data files by extracting textual fields, numerical fields, and other document attributes, and/or by assigning task code labels, activity code labels, expense code labels, or combinations thereof to line items or other portions of the document data. In this manner, the system may prepare heterogeneous document data for coordinated evaluation by a ML model layer.

For instance, the ML model layer can execute multiple audit processes on the pre-processed document data to identify different categories of issues. The ML model layer can have specifically trained ML sub-models designed to evaluate line items within a single document to identify potentially duplicative entries, compare line items across multiple documents to identify repeated billing of similar services, assess compliance with customer-specific billing guidelines, and/or compare billing patterns against benchmark information to identify outlier charges or inefficiencies. In some embodiments, the system may selectively invoke different ML-based audit routines or different artificial intelligence models based on assigned codes, detected document characteristics, user-defined audit settings, or other control information established by the data pre-processing operations.

In some scenarios, outputs from the different audit processes may be consolidated into a unified review state and presented through a GUI that enables a user to inspect flagged issues together with associated reasons, supporting data, and available actions. The GUI may uniquely arrange the output data as particular lists, sections and/or icons to present document data, processing data, related matter data, warnings, recommendations, and explanatory information within a coordinated interface. In this way, the user can review multiple categories of issues without relying on separate tools or disconnected reports. The system may further receive user inputs corresponding to approvals, rejections, disputes, code changes, workflow updates, or other review decisions and may update stored data and processing states in response to these user inputs.

In some instances, the disclosed technology may improve computerized document review by reducing repetitive parsing of heterogeneous source formats, reducing unnecessary execution of audit logic that is not relevant to a particular document, and reducing storage of duplicative intermediate data and separate audit outputs. The disclosed technology may also improve review accuracy and consistency by combining duplicate detection, compliance analysis, coding assistance, and benchmark-based evaluation within a shared processing framework and a unified interface. As a result, the system may reduce manual review effort, reduce error propagation associated with fragmented review workflows, improve responsiveness of the computing environment, and increase efficiency and reliability of machine-assisted invoice review. Moreover, the disclosed technology results in an improved GUI that can present multiple data outputs of different ML sub-models of the ML model layer in a specialized arrangement (e.g., a single view, a scrollable view, and so forth).

Additional benefits and advantages of the presently disclosed technology will become apparent from the detailed description below.

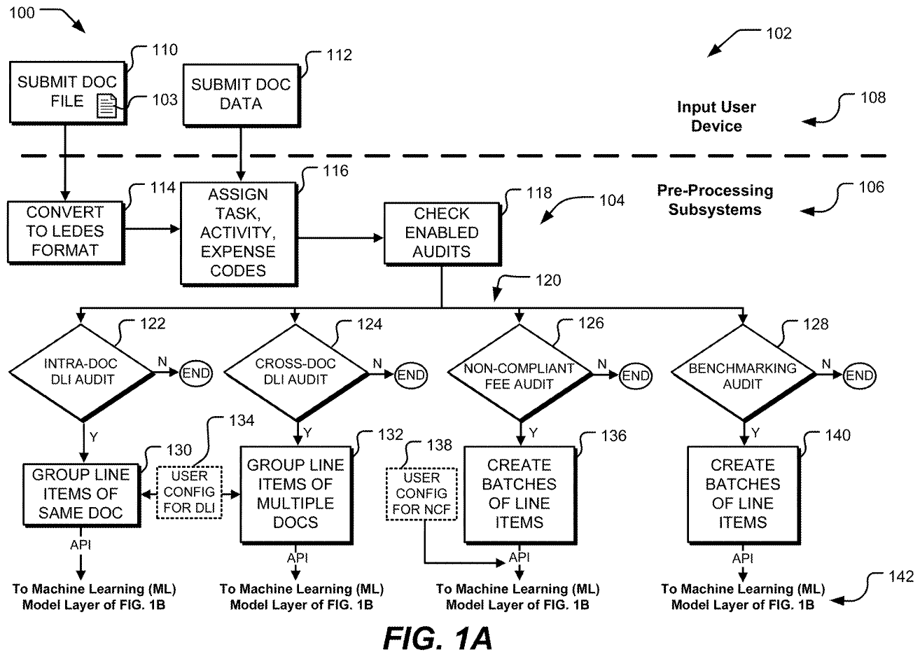

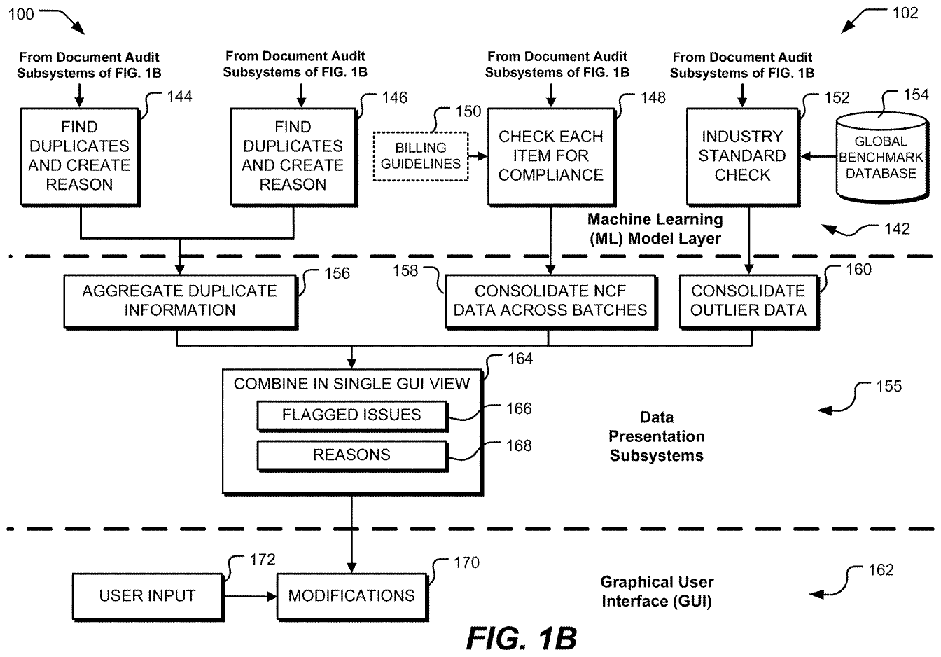

FIGS. 1A and 1B illustrate a system 100 including an ML-based document audit system 102 configured to transform raw document information (e.g., invoice document data files) into a specialized graphical user interface (GUI) 162. The ML-based document audit system 102 can include various interoperable software components to perform data prep-processing operations, machine learning-based analysis, rules-based analysis, GUI rendering operations, and/or combinations thereof. The disclosed system 100 can enhance document processing algorithms for data-dense documents containing narrative text descriptions, numerical values, class values, and other heterogeneous data fields that are difficult to evaluate efficiently using other techniques. The ML-based document audit system 102 may be configured to improve consistency of review, identify discrepancies that may be overlooked during human review, and support efficient compliance checking against customer-specific requirements in a way that lowers computational processing requirements and memory storage requirements of the computing device executing the ML-based document audit system 102.

In some cases, the ML-based document audit system 102 receives source document information 103 from an input user device 108. The source document information 103 may be received via a submit document file operation 110 to receive the data file itself, a submit document data operation 112 to receive additional metadata associated with the document data file, or both (e.g., via a web portal or application executing at the input user device 108). The source document information 103 may include a plurality of documents having a common purpose and/or at least partially similar document structures or document sections. For instance, the source document information 103 can be a native structured invoice, a semi-structured invoice, an unstructured invoice, a portable document format invoice, or other billing-related document information. In some cases, when the received information is not already provided in a target structured format, the ML-based document audit system 102 can perform a Legal Electronic Data Exchange Standard (LEDES) format conversion 114 to convert the received source document information 103 into an LEDES format, or another normalized format suitable for downstream processing. In some cases, the LEDES format conversion 114 uses optical character recognition to extract textual and numerical information from a document image or PDF file of the source document information 103 and further uses machine learning-based extraction and transformation routines to generate structured invoice data. Once converted, the resulting structured invoice data can be processed by the same audit routines described herein, including duplicate line item detection, non-compliant fee detection, automated code assignment, billing-guideline compliance analysis, and benchmark-based analysis, so that potential anomalies can be identified regardless of the original invoice format.

In some scenarios, after receipt and/or transformation of the source document information 103 into the LEDES formatted data file, the ML-based document audit system 102 can use additional data pre-processing components 120. For instance, one or more pre-processing subsystems 104 of a data pre-processing layer 106 may perform label assignment operations 116 to assign task codes, activity codes, expense codes, or combinations thereof to line items or other portions of the document information. The label assignment operation(s) 116 may use contextual analysis of fee item descriptions to automatically assign labels, recommend labels, or identify potentially incorrect labels for review. In some scenarios, the assigned labels are used to improve data consistency, support matter cost analysis, and control selection of which downstream audit routines are executed by the ML model layer 142. In some cases, the presence of one or more assigned task codes or expense codes may trigger a first audit process for a first category of line items and a second audit process for a second category of line items.

For example, the ML-based document audit system 102 can perform an enable audit routine execution operation 118 subsequent to the label assignment operation(s) 116. The enable audit routine execution operation 118 may evaluate audit instructions previously provided by a user, customer, or administrator to determine which audit processes are to be applied to the LEDES-formatted and labelled document data. In some instances, the audit instructions designate a first audit process to be performed based on a first presence of at least one task code, activity code, or expense code and designate a second audit process to be performed based on a second presence of at least one task code, activity code, or expense code. The ML-based document audit system 102 may identify a first artificial intelligence model to be used for the first audit process and a second artificial intelligence model to be used for the second audit process. The first and second artificial intelligence models may be different models, different model configurations, different prompt-driven routines, different classifiers, or different semantic comparison pipelines. In some instances, multiple audit processes are executed in parallel or in sequence on the same document information, as discussed in greater detail below.

In some examples, the ML-based document audit system 102 includes data pre-processing components 120 of the data pre-processing layer 106 (e.g., the one or more pre-processing subsystems 104), and an ML model layer 142. The data pre-processing components 120 may normalize extracted fields, parse line-item descriptions, segment document content, tokenize narrative fields, generate embeddings, prepare numerical features, standardize date and currency values, organize line items into analysis groups, and/or perform any combination of these operations. In some examples, the data pre-processing components 120 are configured to process both narrative descriptions and associated numerical data so that downstream audit routines may evaluate semantic similarity, billing guideline compliance, and value-based anomalies using the same underlying data types. This arrangement may be particularly beneficial where conventional language-focused systems are not well suited to determine relationships among numerical entries and narrative descriptions in a coordinated manner.

In some cases, the data pre-processing layer 106 includes an intra-document document line item (DLI) audit subsystem 122, a cross-document DLI audit subsystem 124, a non-compliant fee audit subsystem 126, and a benchmarking audit subsystem 128. Although illustrated as separate subsystems, the disclosed audit functions may be implemented by separate modules, overlapping modules, a common inference framework, or combinations thereof. The intra-document DLI audit subsystem 122 may receive line items and can perform a same document line item grouping operation 130. This same document line item grouping operation 130 can evaluate semantic content of line item descriptions to identify potential duplicates within the same document (e.g., the same invoice), including duplicates expressed using different phrasing or terminology. The cross-document DLI audit subsystem 124 may receive and organize line items by performing a multiple document line items grouping operation 132. The cross-document DLI audit subsystem 124 may compare line items across multiple documents, such as a user-defined group of invoices, to identify fees billed more than once for the same service or activity. In some cases, duplicate line item analysis can be controlled at least in part by user configuration data for DLI 134, which may define comparison scope, grouping rules, similarity thresholds, document sets, time ranges, matter filters, billing period filters, or other review parameters.

In some instances, the non-compliant fee audit subsystem 126 evaluates line items for potential non-compliance with compliance data generated based on customer billing guidelines, law department policies, outside counsel guidelines, or other review rules. The non-compliant fee audit subsystem 126 may use user configuration data 138 to define enabled categories, guideline sources, exception handling, threshold conditions, or combinations thereof. In some instances, the non-compliant fee audit subsystem 126 identifies potentially non-billable or restricted entries, including administrative tasks, clerical tasks, intra-office communications, travel-related charges, multiple-attendee charges, research charges, supervisory work, quality control work, rework, training, educational activity, or block billing. In some instances, block billing can be detected based on analysis of description length, description complexity, use of bundled task language, keywords, or combinations thereof. The disclosed compliance analysis may ingest and interpret customer-specific billing guidelines and may adapt over time as those billing guidelines change. In this manner, the system 100 can improve adherence to client requirements and reduce a risk that non-compliant invoices will be sent.

In some examples, the benchmarking audit subsystem 128 evaluates the document information, such as the LEDES-formatted and labelled document data, against a comprehensive anonymized benchmark database 154 storing aggregated invoice data from multiple matters, firms, customers, industries, jurisdictions, or combinations thereof to identify potential overbilling, outlier charges, or inefficiencies that may not be apparent from the document alone. The benchmarking analysis may compare a received invoice against aggregated legal invoice data to identify hidden discrepancies, inflated rates for particular activities, tasks billed at an inappropriate seniority level, anomalous staffing patterns, deviations from market rates, or other spending irregularities. In some examples, the benchmarking analysis can provide insight useful for cost control, spend optimization, approval decision-making, and negotiation of billing terms.

In some scenarios, the non-compliant fee audit subsystem 126 and/or the benchmarking audit subsystem 128 can create batches of line items 136 and/or 140, respectively, to organize grouped line items into batches suitable for inference by the ML model layer 142. The batching operations may improve computational efficiency and allow the ML model layer 142 to compare related line items within a common context window. In some scenarios, the ML model layer 142 performs semantic similarity analysis, anomaly detection, clustering, ranking, classification, or reasoning generation to determine whether a line item is potentially duplicative and to generate associated explanatory information. In some cases, first output data of the intra-document DLI audit subsystem 122 (e.g., grouped line items of a same document), second output data of the cross-document DLI audit subsystem 124 (e.g., grouped line items from multiple documents), third output data of the non-compliant fee audit subsystem 126 (e.g., first line item batches associated with fee non-compliance), and fourth output data of the benchmarking audit subsystem 128 (e.g., second line item batches associated with benchmark non-compliance), can each be sent to a respective ML sub-model of the ML model layer 142 corresponding to that particular audit subsystem. For instance, the grouped and/or batched output data can be sent to the ML models of the ML model layer 142 via API messages corresponding to the respective ML models.

FIG. 1B illustrates how the ML model layer 142 and a data presentation subsystem 155 interact to generate a consolidated review output (e.g., a “document view”). A first “find duplicates and create reason” operation 144 and a second “find duplicates and create reason” operation 146 may be executed to detect duplicate entries and generate corresponding reasons data based on the first data output and the second data output. These operations may correspond, for example, to duplicate review within a single invoice and duplicate review across multiple invoices, respectively, and can be performed by separate ML models or a common ML model. Duplicate-related outputs may be provided to a duplicate information aggregator 156.

Additionally, an item compliance check operation 148 can be performed on the third data output to analyze line items using billing guidelines data 150. The item compliance check operation 148 can identify potential non-compliant fees, and the resulting outputs may be provided to a non-compliant fee data consolidator 158 which consolidates non-compliant fees across batches. An industry standard check model 152 may compare document data against data from a global benchmark database 154 to identify outlier values, overbilling indicators, or other industry deviations, and resulting outputs may be provided to an outlier data consolidator 160. In some cases, these four separate audit data processing paths can operate in parallel (e.g., or sequentially) using separate ML models, separate prompt flows, or separate decision logic. In this way, a first audit ML model can identify a first invoice audit issue, a second audit ML model can identify a second invoice audit issue different from the first invoice audit issue, and so on for any number of different audit issue categories and corresponding audit subroutines.

In some scenarios, outputs of the plurality of ML sub-models of the ML model layer 142 (e.g., from the duplicate information aggregator 156, the non-compliant fee data consolidator 158, and/or the outlier data consolidator 160) can be combined into a single report and presented through the GUI 162 as the single GUI view 164. The GUI 162 may present flagged issues 166 and reasons data 168 in a consolidated report, a unified report, and/or a single-view data arrangement so that a review user can evaluate multiple categories of issues without switching between separate tools or workflows. For instance, the combined outputs can include duplicate findings, non-compliant fee findings, coding discrepancy findings, benchmark findings, and one or more reason texts associated with those findings. Additionally, the issues 166 can include identified billing anomalies, discrepancies, inefficiencies, overspending conditions across large invoice populations, and/or combinations thereof. These data outputs from the different data processing paths can be presented simultaneously, together, adjacent to each other, in visual proximity to each other, in overlapping windows, or in any combination thereof. Additionally, in some cases, the reasons data 168 can include natural-language explanations, rule references, confidence indicators, comparison summaries, benchmark references, or combinations thereof that help a user understand the outputs of the ML model layer 142.

In some examples, the GUI 162 may receive user input 172 and may generate modifications 170 to the data presented at the GUI 162 responsive to the user input 172. For example, the user input 172 may include approvals, rejections, disputes, coding corrections, threshold selections, comparison-group selections, audit selections, or workflow instructions, and the modifications 170 may reflect updates to displayed information, stored review outcomes, document states, or downstream process states. In some cases, identified anomalies are clearly presented in a consolidated arrangement that allows a user to review and modify an invoice based on the combined outputs of the plurality of ML sub-models, thereby providing a comprehensive overview of potential billing issues, non-compliant fees, coding discrepancies, and benchmarking insights within a single interface.

In some examples, the ML-based document audit system 102 provides technical improvements in computer operation through a particular machine-implemented processing architecture that converts heterogeneous invoice inputs into a common internal data representation and then selectively routes portions of that representation to different data processing engines. More specifically, the system 102 may use the LEDES format conversion 114, and the label assignment operations 116 to generate normalized line-item records, assigned code fields, extracted text fields, numerical value fields, grouping identifiers, and batch identifiers stored as machine-readable data structures in memory. Those data structures are not merely displayed to a user, but are used by the computing device to control internal operation of the data pre-processing layer 106 and the ML model layer 142, including which audit paths are invoked, which line items are compared, which benchmark queries are executed, and which reasoning operations are performed. By using those structured intermediate data files to drive selective execution of the intra-document DLI audit subsystem 122, the cross-document DLI audit subsystem 124, the non-compliant fee audit subsystem 126, and the benchmarking audit subsystem 128, the system 100 can reduce unnecessary model execution, reduce repeated document reconstruction, reduce redundant memory allocation for duplicate working states, and improve the manner in which the computer processes document-review workloads.

In some cases, the system 102 further improves internal computer functionality by synchronizing multiple audit determinations into a unified review state generated from shared underlying data structures rather than from disconnected application modules. For example, the computing device may maintain common references to normalized line-item records and associated metadata while separately executing duplicate detection, compliance analysis, and benchmark analysis, after which the resulting issue data are merged into the single GUI view 164. This coordinated arrangement may reduce inter-process copying of overlapping invoice content, reduce storage of redundant audit artifacts, reduce re-rendering of separate issue-specific interfaces, and reduce processor cycles associated with reconciling inconsistent outputs from independent review tools. In addition, because the GUI 162 receives a unified issue dataset generated from synchronized subsystem outputs, user interactions may be applied directly to a common review state rather than being separately propagated across multiple disconnected processing environments, thereby reducing synchronization errors, reducing reprocessing caused by conflicting updates, and improving throughput and reliability of the underlying computer system. Accordingly, the disclosed architecture is directed to a specific improvement in the way a computer stores, routes, processes, and updates document data within a particular machine environment.

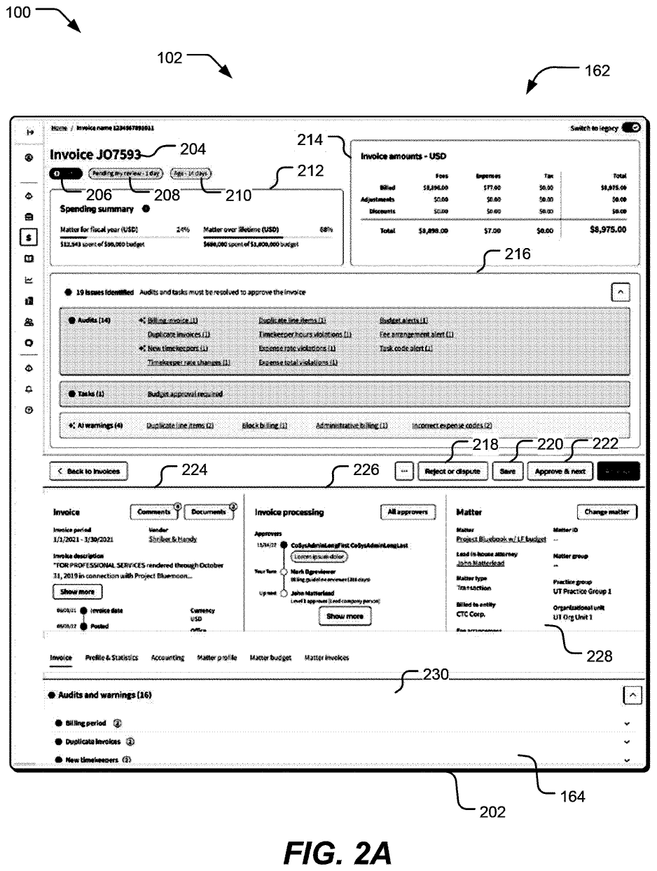

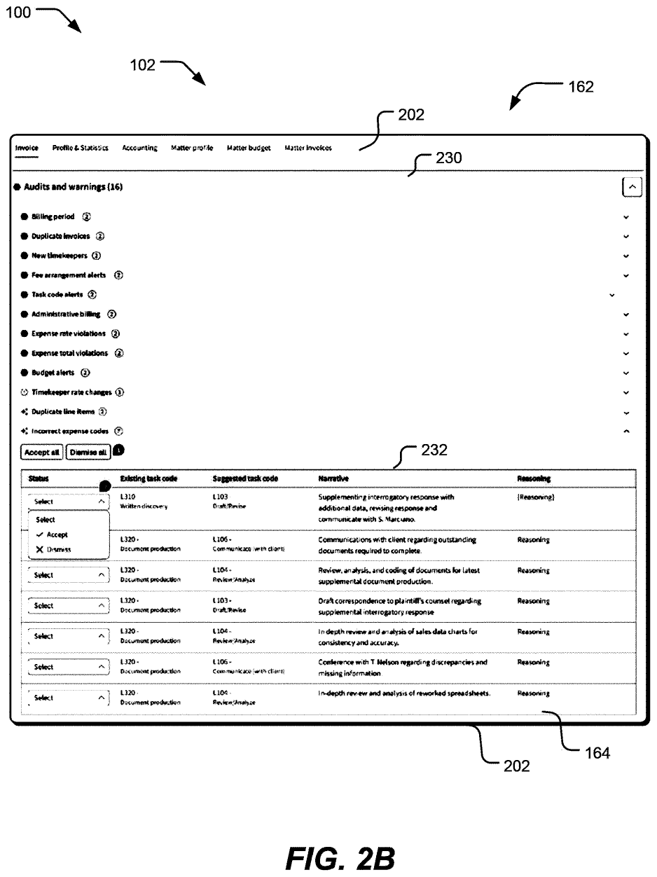

FIGS. 2A and 2B illustrate a user device 202 presenting the GUI 162 with the single GUI view 164 generated by the ML-based document audit system 102. The single GUI view 164 may present a unique arrangement of icons and/or visual indicators representing the data of the ML-based document audit system 102, such as a document identifier 204 identifying the invoice or other document under review, an audits alert indicator 206, a status with time threshold indicator 208, and/or a document age indicator 210. In some instances, the audits alert indicator 206 indicates whether one or more audit conditions have been detected, the status with time threshold indicator 208 indicates whether the document is approaching or has exceeded a review timing threshold, and the document age indicator 210 indicates elapsed time associated with the document. The single GUI view 164 may further include a spending summary section 212 and document aggregated calculations 214. The spending summary section 212 may present summary financial information, budget-related information, or historical comparison information associated with the document, while the document aggregated calculations 214 may present totals, subtotals, category values, approved values, challenged values, savings estimates, or other derived calculations generated by the ML-based document audit system 102.

In some examples, the GUI 162 further includes a flagged issue indicator section 216, a reject or dispute interactive element 218, a save interactive element 220, and an approve interactive element 222. The flagged issue indicator section 216 may present visual indicators corresponding to duplicate content, non-compliant fees, coding discrepancies, benchmark anomalies, or other issues identified by the disclosed audit routines. The reject or dispute interactive element 218 may enable a user to initiate a challenge, rejection, or dispute workflow. The save interactive element 220 may enable interim saving of user selections or modifications. The approve interactive element 222 may enable the user to approve the document, an invoice amount, a set of line items, or another review outcome. The GUI 162 can also present one or more navigation elements for navigating to a different document or a list of documents which can be used to select a new document for presentation. In some examples, the single GUI view 164 further includes a document data section 224, a document processing data section 226, a related matter data section 228, and an audits and warning section 230. The document data section 224 may present source document data, extracted line-item data, descriptions, codes, or value fields. The document processing data section 226 may present approval state, routing state, workflow state, or review state information. The related matter data section 228 may present matter-level context, such as matter identifiers, matter budget information, responsible personnel, customer-specific guideline information, or other contextual information relevant to review of the document. The audits and warning section 230 may present warnings, recommendations, audit outcomes, and issue summaries generated by the ML-based document audit system 102.

FIG. 2B illustrates another view of the GUI 162 presented by the user device 202 (e.g., which can be combined with the single GUI view 162 of FIG. 2A, for instance, by scrolling down). The single GUI view 164 of FIG. 2B may include the audits and warning section 230 together with a modifications and reasoning section 232. The modifications and reasoning section 232 may present proposed modifications, accepted modifications, user-entered revisions, explanatory statements, reason codes, narrative review content, or machine-generated reasoning associated with identified issues. In some cases, the modifications and reasoning section 232 supports attorney review by surfacing narrative explanations and cost saving opportunities associated with flagged line items, thereby reducing the need for manual inspection of every fee item description. Each of these sections of the GUI 162 is discussed in greater detail below.

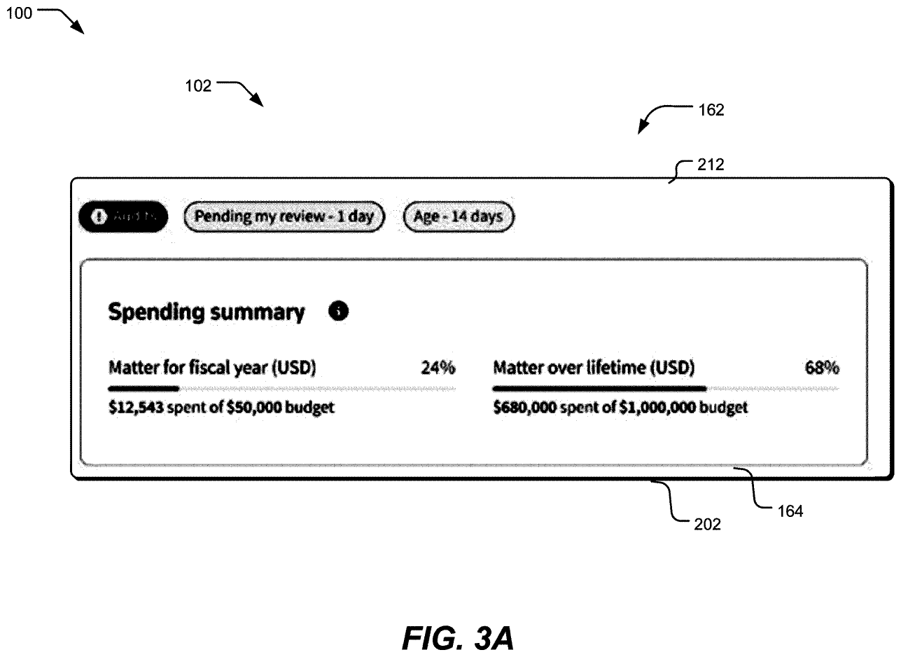

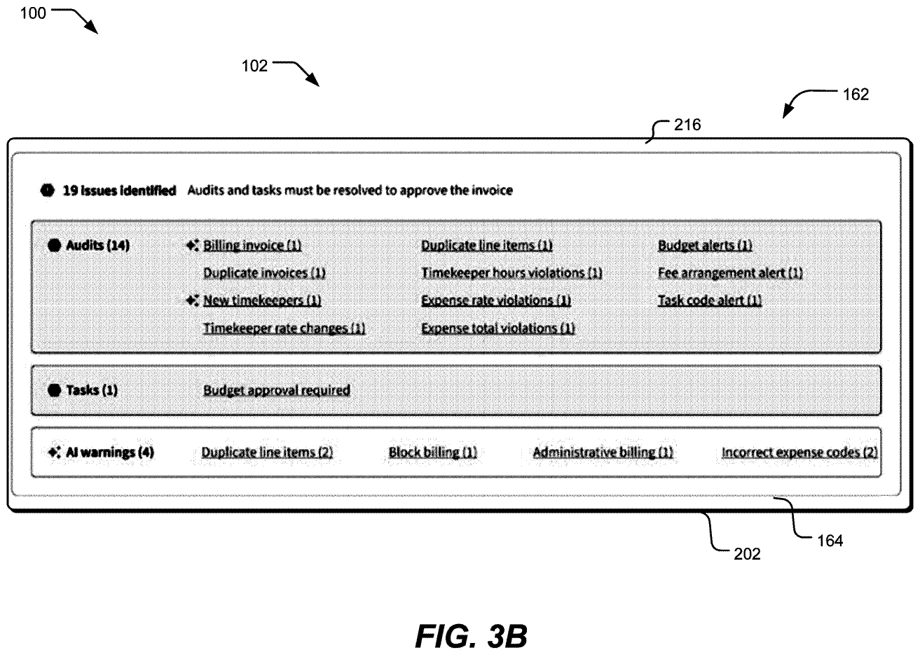

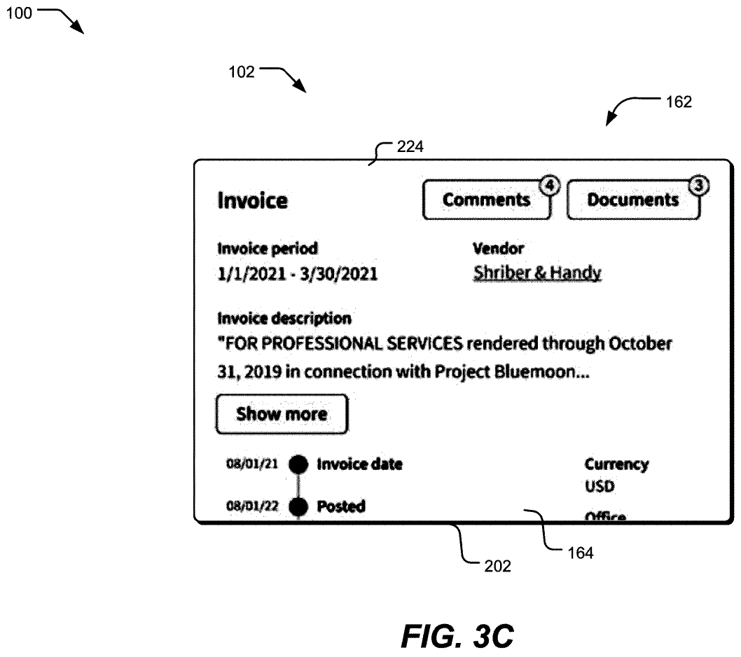

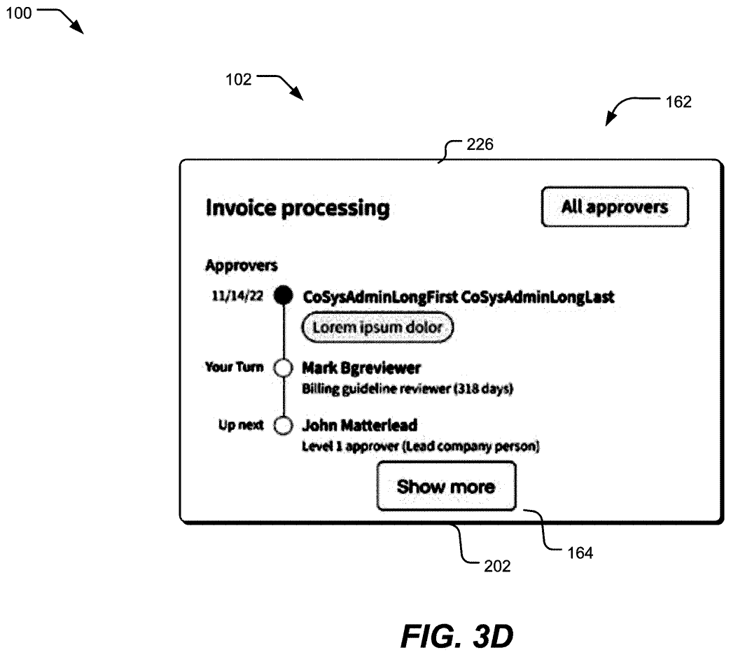

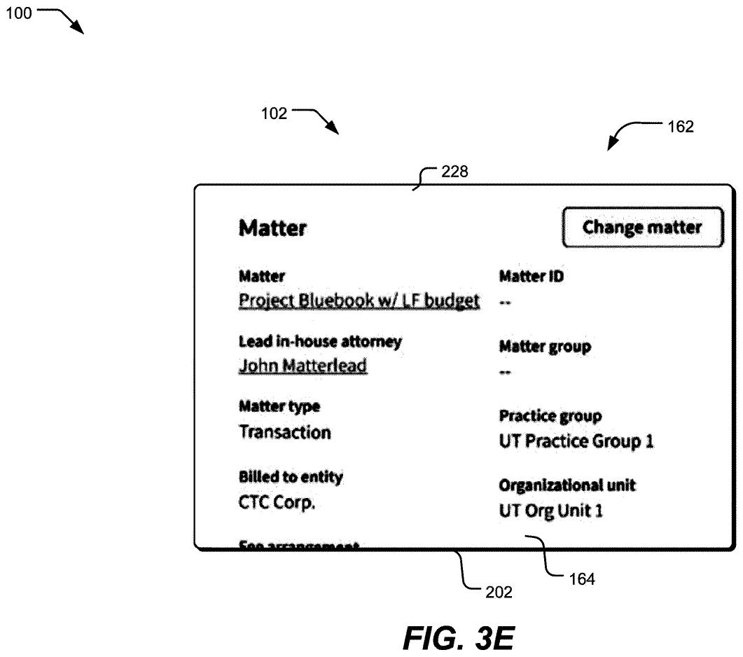

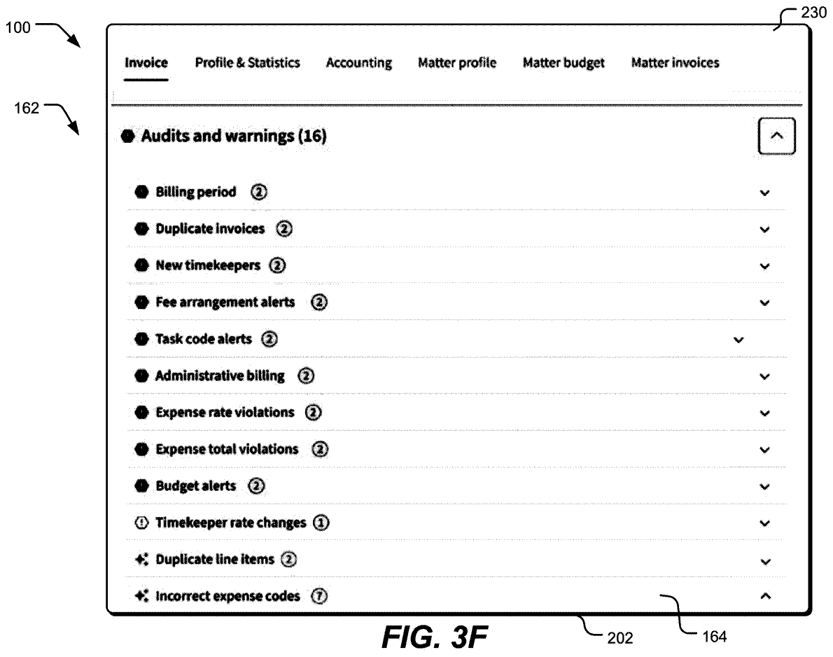

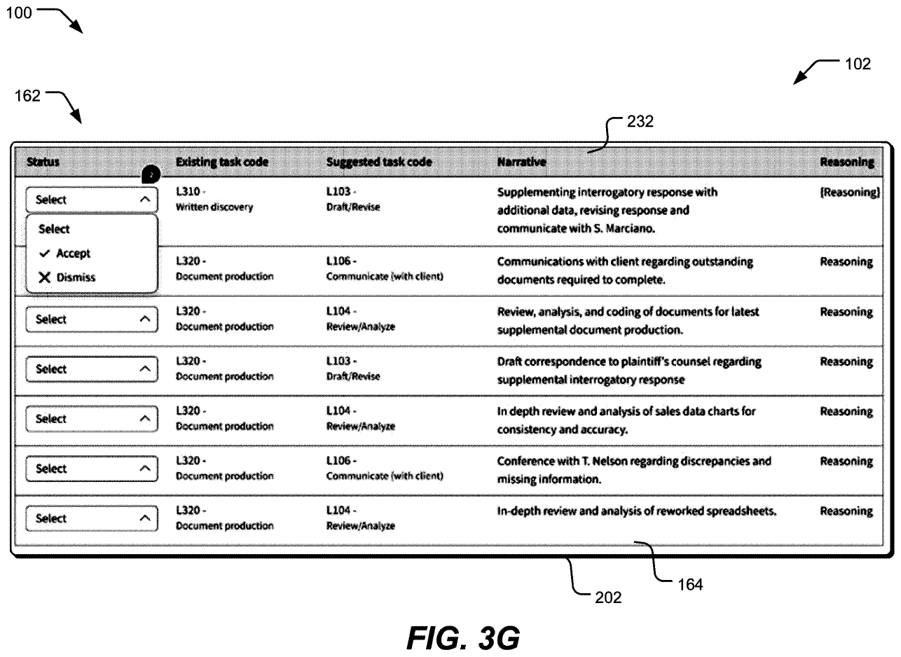

FIGS. 3A-3G illustrate the various components of the GUI 162 in greater detail. FIG. 3A illustrates a focused view of the GUI 162 in which the single GUI view 164 includes the spending summary section 212. This spending summary section 212 may present a condensed financial summary for a reviewed invoice, including one or more totals, categorized amounts, budget comparisons, approved amounts, disputed amounts, or estimated savings values. In some scenarios, the focused presentation enables rapid understanding of invoice magnitude, spending pattern, and review status. For example, the spending summary section 212 can include a first visual indicator (e.g., line or bar) showing matter spending for the fiscal year as compared to an annual budget, and a second visual indicator showing matter spending over its lifetime as compared to a lifetime budget.

FIG. 3B illustrates a focused view of the GUI 162 in which the single GUI view 164 includes the flagged issue indicator section 216. The flagged issue indicator section 216 may aggregate or prioritize issues identified by the intra-document DLI audit subsystem 122, the cross-document DLI audit subsystem 124, the non-compliant fee audit subsystem 126, and/or the benchmarking audit subsystem 128 so that the user can quickly assess substantive review concerns. In some instances, issue indicators are ranked, grouped, color-coded, or otherwise organized to improve user understanding of audit severity or actionability. In some cases, the flagged issue indicator section 216 can include a visual indication of the number of identified issues with a statement that the issues must be resolved before the invoice can be approved (e.g., before activation of an approval interactive element can occur). The flagged issue indicator section 216 can include a first portion identifying types of audits with number indicators representing the numbers of audits (e.g., billing invoice, duplicate invoice, new timekeepers, timekeeper rate changes, duplicate line items, timekeeper hours violations, expense rate violations, expense total violations, budget alerts, fee arrangement alerts, and/or task code alerts). These indicators can be generated as links which, upon receiving a user selection, cause the system 100 to retrieve the document and/or present a portion of the document corresponding to the selected link. Moreover, the flagged issue indicator section 216 can include a second portion indicating task types and/or a number of tasks (e.g., “budget approval required”), and/or a third portion indicating types of warnings and a number of warnings generated by the ML model layer 142. The flagged issue indicator section 216 can further indicate which indicators are generated by the ML model layer 142, for instance, with an icon or an “AI” label.

FIG. 3C illustrates a focused view of the GUI 162 in which the single GUI view 164 includes the document data section 224. The document data section 224 may present underlying document information of the source document information 103 and extracted fields, assigned task codes, assigned activity codes, assigned expense codes, recommended alternative codes, numerical values, or other source data supporting the audit results. The underlying document information can include an invoice time period, a vendor identifier, a link to document comments, a link to the document files, a document description (e.g., an invoice description), a document timeline, a currency type associated with the document, and/or any combination thereof. This section may allow the user to compare raw document information with the flagged issues and reasoning generated by the ML-based document audit system 102.

FIG. 3D illustrates a focused view of the GUI 162 in which the single GUI view 164 includes the document processing data section 226. The document processing data section 226 may present routing information, processing history, reviewer assignments, approval progression, pending actions, or escalation information associated with the invoice review process. In this manner, the disclosed interface may integrate substantive audit review with operational workflow management. For instance, the document processing data section 226 can include a timeline with approvers and dates showing which personnel have performed actions for the document and/or which personnel is currently assigned to perform the next action for the document. Additionally, the document processing data section 226 can include an interactive element which, upon receiving a user input, causes the GUI 162 to present a list of all approver personnel associated with the document.

FIG. 3E illustrates a focused view of the GUI 162 in which the single GUI view 164 includes the related matter data section 228. The related matter data section 228 may present matter-specific data associated with a selected document. This information can be used during audit processing or user review. For instance, the related matter data section 228 can include a matter identifier associated with the document, lead personnel responsible for the matter and/or the document (e.g., a lead in-house attorney name), a matter type indicator (e.g. “transaction”), a billed entity identifier, a matter identifier, a matter group identifier, a practice group identifier, an organizational unit identifier, and/or any combination thereof. The related matter data section 228 can also include an interactive element which, upon receiving a user input, causes the GUI 162 to present an option to change the matter information associated with the document. As depicted in FIG. 2A, the document data section 224, the document processing section 226, and the related matter data section 228 can be presented simultaneously as a row of sections and/or adjacent to each other. Moreover, these sections (e.g., and other sections disclosed herein) may include an expansion interactive element (e.g., a “show more” button) which, upon receiving a user input, causes the particular section to expand by retrieving and presenting additional data corresponding to that section.

FIG. 3F illustrates a focused view of the GUI 162 in which the single GUI view 164 includes the audits and warning section 230. The audits and warning section 230 may present a consolidated listing of identified issues or anomalies, including duplicate line items, incorrect or questionable coding, non-compliant fees, billing-guideline issues, benchmark outliers, and other issues detected by the ML model layer 142. In some instances, the displayed audit categories correspond to user-enabled audit routines and may be filtered according to billing period, matter, document group, issue type, or severity. Additionally, the audits and warning section 230 can include a row of selectable GUI elements which determine, responsive to a user input, what information is displayed at the GUI. These selectable GUI elements can include an invoice element, a profile and statistics element, an accounting element, a matter profile element, a matter budget element, a matter invoice element, and/or any combination thereof. Furthermore, the audits and warning section 230 can list selectable GUI elements indicating categories of the audits and warnings (e.g., with corresponding number indicators showing a number of items in each category), such as a billing period category, a duplicate invoices category, a new timekeepers category, a fee arrangement alerts category, a task code alerts category, an administrative billing category, an expense rate violations category, an expense total violations category, a budget alerts category, a timekeeper rate changes category, a duplicate line items category, an incorrect expense codes category, and/or any combination thereof. These category indicators can also include an icon indicating a severity level of the category and/or whether the category indicator is an output from the ML model layer 142. Drop-down arrows for each category can receive a user input causing the category indicator to expand and present the underlying document data associated with that category.

FIG. 3G illustrates a focused view of the GUI 162 in which the single GUI view 164 includes the modifications and reasoning section 232. The modifications and reasoning section 232 may present various outputs of the ML model layer 142 such as reasoning associated with automatically assigned codes, proposed task code changes, duplicate findings, compliance findings, benchmark findings, and/or other narrative descriptions. In some examples, the reasoning includes explanatory text generated by the ML model layer 142 to identify the basis for a recommendation, such as a semantic similarity between line items, a mismatch with customer billing guidelines, an inconsistency with historical coding patterns, or a deviation from benchmark data. This arrangement may increase user trust in automated decision-making and assist a reviewer in validating or overriding machine generated output. For instance, the modifications and reasoning section 232 can include a plurality of rows with each individual row corresponding to an existing task code of the document, a suggested task code, and an ML-generated narrative explaining the reasoning for changing the existing task code to the suggested task code. The individual row can also include an interactive element (e.g., a drop down menu, a button, etc.) which, upon receiving user input, causes a modification to the document by replacing the existing task code with the suggested task code.

As shown herein, any combination of the sections of the GUI 162 depicted in FIGS. 2A-3G can be arranged adjacent to each other, above or below each other, simultaneously, and/or as one or more windows to form the single GUI view 164. Furthermore, any of the visual indicators and/or interactive elements of the sections of the GUI 162 disclosed herein can be a default feature automatically generated by the GUI 162 and/or can be a customized feature, unique to the particular source document, and generated by the ML model layer 142. Additionally, components of any section can be combined with any other section.

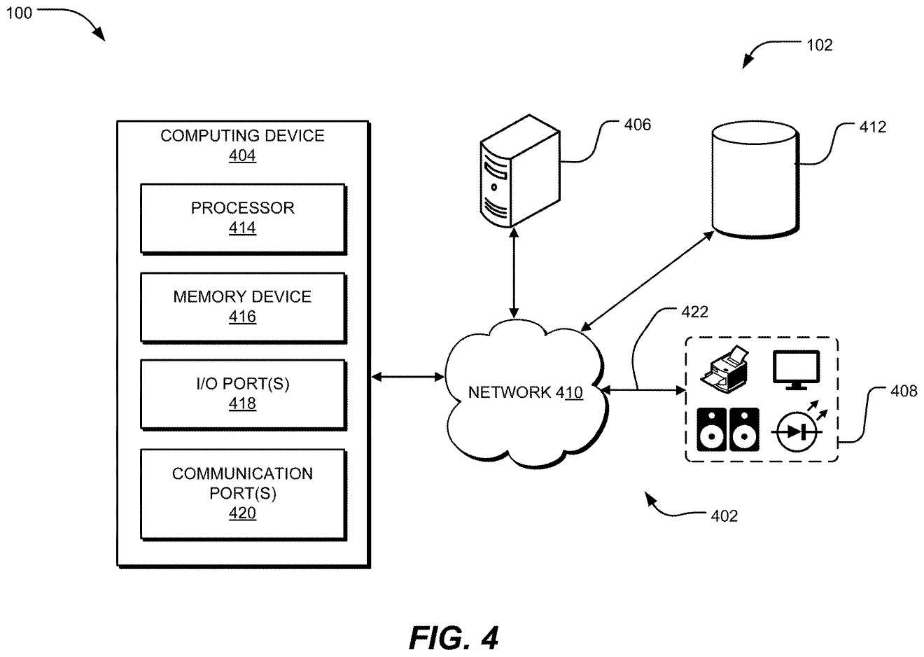

FIG. 4 illustrates an example system 100 including a network architecture 402 for implementing the ML-based document audit system 102. The network architecture 402 may include one or more computing device(s) 404, one or more server(s) 406, external physical systems 408, a network 410, and/or one or more database(s) 412. The computing device 404 may include a processor 414, a memory device 416, one or more I/O ports 418, and one or more communication ports 420. The network 410 may communicatively couple client devices, servers 406, data repositories, and the external physical systems 408, as discussed in greater detail below.

In some examples, the one or more computing devices 404 can include a variety of different device types. For instance, the computing device(s) 404 can include an edge computing device performing any or all of the operations locally, and/or a remote server device 406 hosting a service provider API or software that provides the ML-based document audit system 102 as a “SaaS” (e.g., with any or all of the components or subsystems of the ML-based document audit system 102). Additionally or alternatively, the ML-based document audit system 102 can be fully or partly deployed on-premises at a third-party server device, another third-party computing device (e.g., via integration into a third-party software platform) and/or integrated into circuitry of various hardware devices which may perform data processing. The ML-based document audit system 102 may also be accessed remotely by and/or may send instructions to one or more external physical system(s) 408 (e.g., and/or external physical devices).

Moreover, in some instances, the computing device(s) 404 can include a computer, a personal computer, a desktop computer, a laptop computer, a terminal, a workstation, a cellular or mobile phone, a mobile device, a smart mobile device, a tablet, a wearable device (e.g., a smart watch, smart glasses, a smart epidermal device, etc.), a multimedia console, a television, an Internet-of-Things (IoT) device, a smart home device, a virtual reality (VR) device, an augmented reality (AR) device, a vehicle and/or a vehicle device, or the like.

In some examples, the computing device(s) 404 discussed herein can communicate via one or more network(s) 410 including any type of network, such as the Internet, an intranet, a Virtual Private Network (VPN), a Voice over Internet Protocol (VoIP) network, a wireless network (e.g., Bluetooth), a cellular network (e.g., 4G, LTE, 5G, 6G, etc.), a satellite network, combinations thereof, etc. The network(s) 410 can include communications network(s) with numerous components, such as gateways, routers, server(s) 406, and registrars, which enable communication across the network 410. In one implementation, the communications network(s) include multiple ingress/egress routers, which may have one or more ports, in communication with the network 410. Additionally, or alternatively, the computing device(s) 404 and/or the server(s) 406 can access and be accessed by the network 410 via another type of communications network, which may be a public switched telephone network (PSTN) operated by a local exchange carrier (LEC).

In some instances, at least one server 406 can host a website or application of the ML-based document audit system 102, such as a web client application and/or a download link, to provide access to the subsystems and/or GUIs 162 disclosed herein. The computing device(s) 404 may visit the hosted website to access the ML-based document audit system 102 and/or to send inputs to the ML-based document audit system 102. To perform the operations disclosed herein, the server(s) 406 and/or the edge computing device can access (e.g., read and/or write) one or more database(s) 412. Additionally or alternatively, some or all of the software components of the ML-based document audit system 102 disclosed herein can be downloaded, stored and/or executed locally at the edge computing device (e.g., a client device such as the user input user device 108). An application of the ML-based document audit system 102 can receive the inputs and can analyze the inputs to generate the outputs discussed herein, which can be stored at the database(s) 412.

Furthermore, the server 406 may be a single server, a plurality of servers with each server being a physical server or a virtual machine, or a collection of both physical servers and virtual machines. In another implementation, the ML-based document audit system 102 hosts components of its subsystems (e.g., the ML sub-models of the ML model layer 142, the audit subsystems, and so forth) on separate servers 406 operating in parallel. The server(s) 406 may host one or more model services, audit engines, conversion services, or application services associated with the ML-based document audit system 102. The server(s) 406 may represent an instance among large instances of application servers in a cloud computing environment, a data center, or other computing environment. Additionally, the database 412 may store document data, extracted data, code assignments, billing guidelines data 150, user configuration data for DLI 134, user configuration data for non-compliant fees 138, the global benchmark database 154, audit results, reasoning data, workflow data, historical review outcomes, user input records, and/or any combination thereof.

Additionally, the computing device 404 may be a computing system capable of executing a computer program product to execute a computer process. Data and program files may be input to the computing device 404, which reads the files and executes the programs therein. Some of the elements of the computing device 404 can include one or more hardware processors 414, one or more memory devices 416, and/or one or more ports, such as input/output (IO) port(s) 418 and communication port(s) 420. Various elements of the computing device 404 may communicate with one another by way of the communication port(s) 420 and/or one or more communication buses, point-to-point communication paths, or other communication means.

The processor 414 may include, for example, a central processing unit (CPU), a microprocessor, a microcontroller, a digital signal processor (DSP), a graphics processing unit (GPU), a quantum processor, and/or one or more internal levels of cache. There may be one or more processors 414, such that the processor 414 comprises a single processing unit, or a plurality of processing units capable of executing instructions and performing operations in parallel with each other, referred to as a parallel processing environment, which can be across multiple CPUs and/or GPUs. In some cases, the processor 414 executes the instructions stored in the memory device 416 or otherwise accessible to the computing device 404 to cause performance of document ingestion, optical character recognition, format conversion, data normalization, label assignments, duplicate detection, compliance analysis, benchmark analysis, reasoning generation, GUI rendering, and/or any combination thereof.

The computing device 404 may be a single computer, a plurality of computers (e.g., a distributed computer), or another type of computer, such as one or more external computers made available via the cloud computing architecture. The presently described technology is optionally implemented in software stored on a data storage device(s) such as the memory device(s) 416 (e.g., locally stored at the computing device 404), and/or communicated via one or more of the ports 418 or 420, thereby transforming the computing device 404 into a special-purpose machine for generating the GUI 162, and/or for sending control instructions 422 to external physical systems 408 (e.g., control systems and/or control processors of the external physical systems 408) to perform automated physical actions responsive to the outputs of the ML-based document audit system 102.

For instance, the external physical systems 408 may include a printer, and the control instruction 422 (e.g., control signal) can be sent to the printer to generate a physical paper copy of the GUI 162 and/or a portion of the GUI 162. The external physical systems 408 may include a visual alert system with one or more lights or light emitting diodes (LED), and the ML-based document audit system 102 can send a control instruction 422 to the visual alert system to cause a particular LED or light to illuminate responsive to the identification of an issue. For example, one color LED (e.g., red) may illuminate to represent the presence of an issue, whereas another color (e.g., green), may illuminate to represent the absence of an issue. In some cases, the control instructions 422 may be sent to a visual display monitor to cause particular pixels to illuminate in response to the outputs of the ML-based document audit system 102. Furthermore, the external physical system 408 may include an audio speaker, and the control instruction 422 can cause the audio speaker to generate a particular audio alert representing outputs of the ML-based document audit system 102. In some cases, the external physical systems 408 include third-party repositories, billing systems, matter management systems, OCR systems, or other data sources supplying information to or receiving information from the ML-based document audit system 102.

Moreover, in some cases, the computing device 404 may comprise a special-purpose device with particular hardware components specifically combined together, such that the special-purpose device is designed to implement the ML-based document audit system 102 to provide a real-time, low-computational overhead, highly energy efficient document audit tool (e.g., by using one or more of the control instruction(s) 422). For instance, the computing device 404 can include a camera for receiving the input data 107 as image data, a microphone for receiving the input data 107 as audio data, a light to be illuminated in response to the outputs, and/or a microphone to generate an audio alert in response to the outputs. This type of special-purpose device may include a simplified printed circuit board (PCB) to integrate these components together and can be designed with a minimal form factor to provide quick, low-processing, energy efficient, assessments of high volumes of documents using the ML-based document audit system 102.

The one or more memory device(s) 416 may include any non-volatile data storage device capable of storing data generated or employed within the computing device 404, such as computer executable instructions for performing a computer process, which may include instructions of both application programs and an operating system (OS) that manages the various components of the computing device 404. The memory device(s) 416 may include magnetic disk drives, optical disk drives, solid state drives (SSDs), flash drives, and the like. The memory device(s) 416 may include removable data storage media, non-removable data storage media, a quantum memory device, and/or external storage devices made available via a wired or wireless network with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 416 may include volatile memory (e.g., dynamic random-access memory (DRAM), static random-access memory (SRAM), etc.) and/or non-volatile memory (e.g., read-only memory (ROM), flash memory, etc.).

The memory device(s) 416 which may be referred to as machine-readable media which can include tangible non-transitory medium capable of storing or encoding instructions to perform operations of the system 100 are disclosed herein. The machine-readable media can store computer-readable instructions for execution by a machine, and/or can be capable of storing or encoding data structures and/or algorithmic modules utilized by or associated with such instructions.

In some implementations, the computing device 404 can include one or more ports, such as the I/O port 418 and the communication port 420, for communicating with other computing, network, or devices. It will be appreciated that the I/O port 418 and the communication port 420 may be combined or separate and that more or fewer ports may be included in the computing device 404.

The I/O port 418 may be connected to an I/O device, or other device, by which information is input to or output from the computing device 404. For instance, input devices can convert a human-generated signal, such as human voice, physical movement, physical touch or pressure, and/or the like, into electrical signals as input data into the computing device 404 via the I/O port 418. Similarly, output devices may convert electrical signals received from the computing device 404 via the I/O port 418 into signals that may be sensed as output by a human, such as sound, light, and/or touch, or may be converted into the control instructions 422. The input device may be an alphanumeric input device, including alphanumeric and other keys for communicating information and/or command selections to the processor 414 via the I/O port 418. The input device may be another type of user input device including direction and selection control devices, such as a mouse, a trackball, cursor direction keys, a joystick, a wheel, and/or one or more sensors, such as a camera, a microphone, a positional sensor, an orientation sensor, an inertial sensor, an accelerometer; and/or a touch-sensitive display screen (“touchscreen”). The output devices may include, without limitation, a display, a touchscreen, a speaker, a tactile or haptic output device, and/or the like. In some implementations, the input device and the output device may be the same device, for example, in the case of a touchscreen.

In some examples, the communication port 420 can be connected to the network 410, and the computing device 404 may receive network data useful in executing the methods and systems set out herein as well as transmitting information and network configuration changes determined thereby. Stated differently, the communication port 420 can connect the computing device 404 to one or more communication interface devices configured to transmit and/or receive information between the computing device 404 and other devices by way of one or more wired or wireless communication networks or connections. Examples of such network connections include Universal Serial Bus (USB), Ethernet, Wi-Fi, Bluetooth®, Near Field Communication (NFC), or any other network connection interface of the network 410. For instance, one or more such communication interface devices may be utilized via the communication port 420 to communicate with one or more other machines, either directly over a point-to-point communication path, over a wide area network (WAN) (e.g., the Internet), over a local area network (LAN), over a cellular network, over an intelligent transport system (ITS) or over another communication means. Further, the communication port 420 may communicate with an antenna or other link for electromagnetic signal transmission and/or reception.

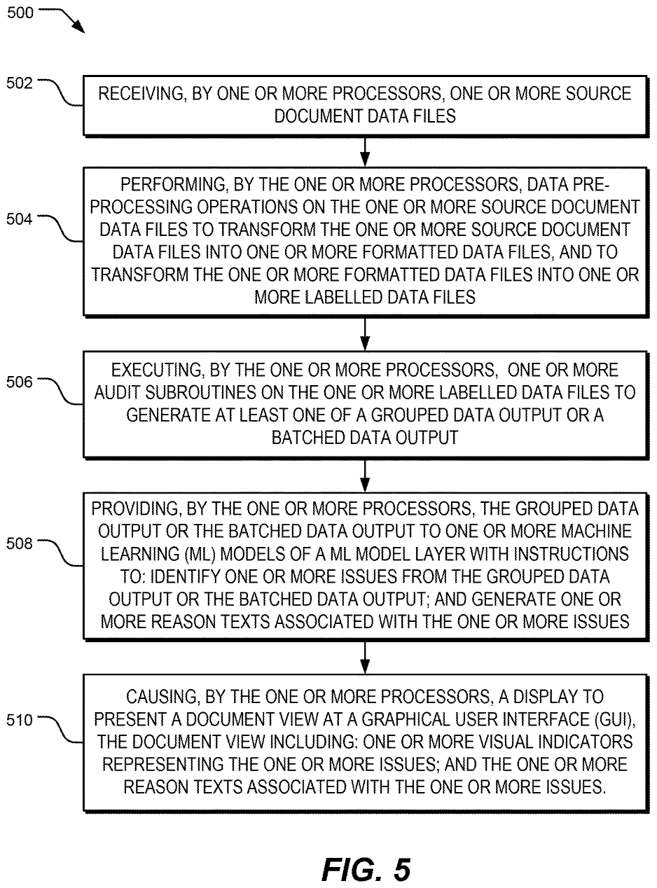

FIG. 5 illustrates example method(s) 500 of automated document auditing and generating a GUI.

For example, at operation 502, the method 500 can receive, by one or more processors, one or more source document data files. At operation 504, the method 500 can perform, by the one or more processors, data pre-processing operations on the one or more source document data files to transform the one or more source document data files into one or more formatted data files, and to transform the one or more formatted data files into one or more labelled data files. At operation 506, the method 500 can execute, by the one or more processors, one or more audit subroutines on the one or more labelled data files to generate one or more subroutine outputs (e.g., at least one of a grouped data output or a batched data output). At operation 508, the method 500 can provide, by the one or more processors, the one or more subroutine outputs to one or more machine learning (ML) models of a ML model layer with instructions to: identify one or more issues from the one or more subroutine outputs; and generate one or more reason texts associated with the one or more issues. At operation 510, the method 500 can cause, by the one or more processors, a display to present a document view at a graphical user interface (GUI), the document view including: one or more visual indicators representing the one or more issues; and the one or more reason texts associated with the one or more issues.

Although FIG. 5 illustrates a particular sequence, in other scenarios one or more operations may be omitted, combined, repeated, subdivided, performed in parallel, or performed in a different order.

In some instances, the disclosed arrangements enable a review user, such as legal operations personnel, attorneys, or other authorized personnel, to evaluate outside counsel invoices more efficiently than with fragmented manual workflows. By combining machine learning-based duplicate detection, billing-guideline compliance analysis, automated coding, benchmark-based anomaly detection, OCR-supported format conversion, and consolidated presentation of results through the GUI 162, the system 100 may reduce review time, improve identification of billing discrepancies, and support more consistent and informed review decisions.

It is to be understood that the scope of the present application is not intended to be limited to the particular embodiments of the process, machine, manufacture, composition of matter, means, methods and steps described in the specification. Moreover, any system, or subcomponent thereof, disclosed in any of FIGS. 1A-5 can be similar to, identical to, combined with, and/or can form at least a portion of any system, or subcomponent thereof, of FIGS. 1A-5.

What is claimed is:

1. A system comprising:
one or more processors;
a display; and
one or more non-transitory memory storage device storing computer-readable instructions which, upon being executed by the one or more processors, cause the system to perform operations including:
assigning one or more task code labels or expense code labels to one or more formatted document data files to transform the formatted document data files into one or more labelled data files;
selecting one or more audit subroutines from a plurality of audit subroutines based on previously-stored subroutine designation instructions corresponding to at least one of the one or more task code labels;
executing one or more audit subroutines on the one or more labelled data files to generate a subroutine output;
providing the subroutine output to one or more machine learning (ML) models of a ML model layer with instructions to:
identify one or more issues from the subroutine output; and
generate one or more reason texts associated with the one or more issues; and
causing the display to present a document view in a graphical user interface (GUI), the document view including:
a document identifier corresponding to the one or more source document data files;
one or more visual indicators representing the one or more issues; and
the one or more reason texts associated with the one or more issues.

2. The system of claim 1, further comprising:
receiving one or more source document data files; and
performing a format conversion procedure on the source document data files to generate the one or more formatted document data files.

3. The system of claim 1, wherein executing the one or more audit subroutines includes selecting the one or more audit subroutines from a group of audit subroutines based on the one or more labelled data files.

4. The system of claim 3, wherein the group of audit subroutines include:
an intra-document document line item (DLI) audit subsystem;
a cross-document DLI audit subsystem;
a non-compliant fee audit subsystem; and
a benchmark audit subsystem.

5. The system of claim 1, wherein the executing of the one or more audit subroutines includes grouping line items from a same source document data file to generate a grouped subroutine output provided to the one or more ML models.

6. The system of claim 1, wherein the executing of the one or more audit subroutines includes grouping line items from multiple source document data files to generate a grouped subroutine output provided to the one or more ML models.

7. The system of claim 1, wherein the executing of the one or more audit subroutines includes batching line items that correspond to non-compliant fees to generate a batched subroutine output provided to the one or more ML models.

8. The system of claim 1, wherein the executing of the one or more audit subroutines includes batching line items that correspond to a benchmark threshold to generate a batched subroutine output provided to the one or more ML models.

9. The system of claim 1, wherein:
the one or more audit subroutines include a plurality of audit subroutines; and
the one or more ML models include a plurality of ML models, with individual ML models of the plurality of ML models corresponding to individual audit subroutines of the plurality of audit subroutines.

10. The system of claim 9, further comprising:
aggregating duplicate line item information based on outputs of the plurality of ML models;
consolidating non-compliant fee data based on the outputs of the plurality of ML models; and
consolidating outlier data based on the outputs of the plurality of ML models, and the one or more visual indicators representing the one or more issues correspond to at least one of aggregated duplicate line item information, consolidated non-compliant fee information, or consolidated outlier data.

11. The system of claim 1, wherein the document view includes:
a visual task code indicator representing a task code associated with the one or more issues;
a visual suggested task code indicator, generated by the ML model layer, representing a suggested task code to replace the task code associated with the one or more issues;
a textual narrative representing a reason for the suggested task code; and
an interactive GUI element that, upon receiving a user input, causes the task code to be replaced with the suggested task code in the one or more source document data files.

12. A device comprising:
one or more processors; and
one or more non-transitory memory storage device storing computer-readable instructions which, upon being executed by the one or more processors, cause the device to perform operations including:
receiving one or more source document data files;
performing data pre-processing operations on the one or more source document data files to transform the one or more source document data files into one or more formatted data files, and to transform the one or more formatted data files into one or more labelled data files;
executing one or more audit subroutines on the one or more labelled data files to generate one or more subroutine output;
providing the one or more subroutine outputs to one or more machine learning (ML) models of a ML model layer with instructions to:
identify one or more issues from the one or more subroutine outputs; and
generate one or more reason texts associated with the one or more issues; and
causing a display to present a document view at a graphical user interface (GUI), the document view including:
one or more visual indicators representing the one or more issues; and
the one or more reason texts associated with the one or more issues.

13. The device of claim 12, wherein the document view includes a spending summary section presenting, based on the one or more subroutine output:
a first visual indicator showing matter spending for a fiscal year as compared to an annual budget; and
a second visual indicator showing matter spending over a lifetime of a matter as compared to a lifetime budget.

14. The device of claim 12, wherein the document view includes a flagged issue indicator section presenting selectable issue indicators corresponding to different audit types.

15. The device of claim 12, wherein the document view includes a document data section presenting a timeline of activity associated with the one or more source document data files.

16. The device of claim 12, wherein the document view includes a document processing data section presenting approval progression activity and pending actions for the one or more source document data files.

17. The device of claim 12, wherein the document view includes a related matter data section presenting matter-specific data associated with the one or more source document data files and including an interactive element configured to present an option to change matter information associated with the one or more source document data files.

18. The device of claim 12, wherein the document view includes a list of a plurality of issue category indicators, and individual issue category indicators of the plurality of issue category indicators include a number indicator representing a number of issues corresponding to the individual issue category indicators.

19. The device of claim 12, wherein the document view includes an interactive element associated with the one or more visual indicators that, upon receiving a user input, causes a section of the document view to present underlying document data associated with the one or more visual indicators.

20. A computer-implemented method comprising:
receiving, by one or more processors, one or more source document data files;
performing, by the one or more processors, data pre-processing operations on the one or more source document data files to transform the one or more source document data files into one or more formatted data files, and to transform the one or more formatted data files into one or more labelled data files;
executing, by the one or more processors, one or more audit subroutines on the one or more labelled data files to generate one or more subroutine outputs;
providing, by the one or more processors, the one or more subroutine outputs to one or more machine learning (ML) models of a ML model layer with instructions to:
identify one or more issues from the one or more subroutine outputs; and
generate one or more reason texts associated with the one or more issues; and
causing, by the one or more processors, a display to present a document view at a graphical user interface (GUI), the document view including:
one or more visual indicators representing the one or more issues; and
the one or more reason texts associated with the one or more issues.
